(19) United States
(12) Patent Application Publication
(10) Pub. No.: US 2010/0235760 A1
(43) Pub. Date: Sep. 16, 2010

(54) METHOD FOR CALIBRATING RELATIVE TIME IN CONTENT OF MESSAGE

(76) Inventor: Luke Goh, Taipei (TW)

Correspondence Address: Dr. BANGER SHIA;Patent Office of Bang Shia, 102 Lindencrest Ct, Sugar Land, TX, 77479-5201, US

(21) Appl. No.: 12/705,602

(22) Filed: Feb. 14, 2010

(30) Foreign Application Priority Data
Mar. 10, 2009 (TW) 098107612

(51) Int. Cl. G06F 15/16; G06F 3/048

(52) U.S. Cl. 715/752; 709/206

(57) ABSTRACT

A method for calibrating a relative time in content of a message is provided. A relative time word is identified in various kinds of transmission information, and the relative time is calibrated to an absolute time according to a sending time of the message. Even a date, a time zone received by the receiver receiving the message is different from that of the sender, the receiver wound not misunderstand due to misinterpretation.

### BACKGROUND OF THE INVENTION

1. Field of Invention

The invention relates to a method for calibrating a relative time in the content of a message and, more particularly, to a method for calibrating a relative time in the content of a message to an absolute time.

2. Related Art

Along with the development of network communication, various kinds of messages transmitted via the communication network are widely applied. These messages include a short message transmitted via a mobile communication appliance, and an instant message and an e-mail message transmitted via the Internet, and they are not only used for personal communication, but also used for business communication. The transmission realized via the e-mail message may reduce the cost of a physical mail.

However, since it is so easy to use these messages, a user easily misunderstands the content of the message due to carelessness. The e-mail message is taken as an example. A client transmits an e-mail message to a supplier, and “call on 8:00 tomorrow” is mentioned in the message. However, if the supplier receives the letter the next day due to busy work, a misconstruction may be formed by the e-mail message because the client calls on the third day. Even a receiving time or a sending time is shown in the e-mail message, a common user often neglect it and only reads the content. Therefore, there is considerable risk that a receiver may not know the day appointed by the sender.

On the other hand, if the message is applied in an international business, a problem also may be resulted. For example, the client in Singapore sends an e-mail to a Japanese client to have a video conference at 3:00 pm. However, since the time difference between Singapore and Japan is one hour, even the receiver notes an appointed time, the time difference may be still neglected. Thus, the Japanese client does not appear when the client in Singapore waits for the Japanese client, and the Japanese client turns on video equipment an hour earlier and also cannot find the Singapore client.

The short message and an instant message also produce the same problem. The instant message is taken as an example. Even the message is instantly transmitted to an electronic equipment at the other side, since an offline message is developed, if the receiver does not note or read the message immediately, a misconstruction may occur. For example, if a user A transmits the instant message to a user B to meet the user B at 10:00 tomorrow, but the user B does not receive the message immediately, user B may receive the message the next day. When turning on the computer the next day, user B may receive the offline message and misinterpret the appointed time to be the third day.

### SUMMARY OF THE INVENTION

According to a method for calibrating a relative time in the content of a message, first, a message is received. The message may be various kinds of messages such as a short message, an instant message, and an e-mail message transmitted via a communication network. Second, the content of the message is identified to confirm that the text description of the relative time is included in the content. The relative time is converted to the absolute time by capturing a sending time of the message and calibrating the relative time in the content according to the sending time, and thus the receiver receiving the message wound not misunderstand due to the time difference, time zone difference between the receiver and the sender.

On the other hand, the relative time may be identified via a relative time keyword. The relative time keywords may include one or the combination of tomorrow, yesterday, the day after tomorrow, the day before yesterday, before, after, time zone, and then they are converted to various kinds of the absolute time including year, month, date, time, time zone to prevent the reader from misunderstanding in reading.

These and other features, aspects and advantages of the present invention will become better understood with regard to the following description, appended claims, and accompanying drawings.

### BRIEF DESCRIPTION OF THE DRAWINGS

FIG. 1 is a flow chart showing a method for calibrating a relative time in the content of a message according to an embodiment of the invention;

FIG. 2A and FIG. 2B are schematic diagrams showing a method for calibrating a relative time in the content of a message according to a first embodiment of the invention;

FIG. 3A and FIG. 3B are schematic diagrams showing a method for calibrating a relative time in the content of a message according to a second embodiment of the invention; and

FIG. 4 is a schematic diagram showing a relative time keyword database of a method for calibrating a relative time in the content of a message according to an embodiment of the invention.

### DETAILED DESCRIPTION OF THE INVENTION

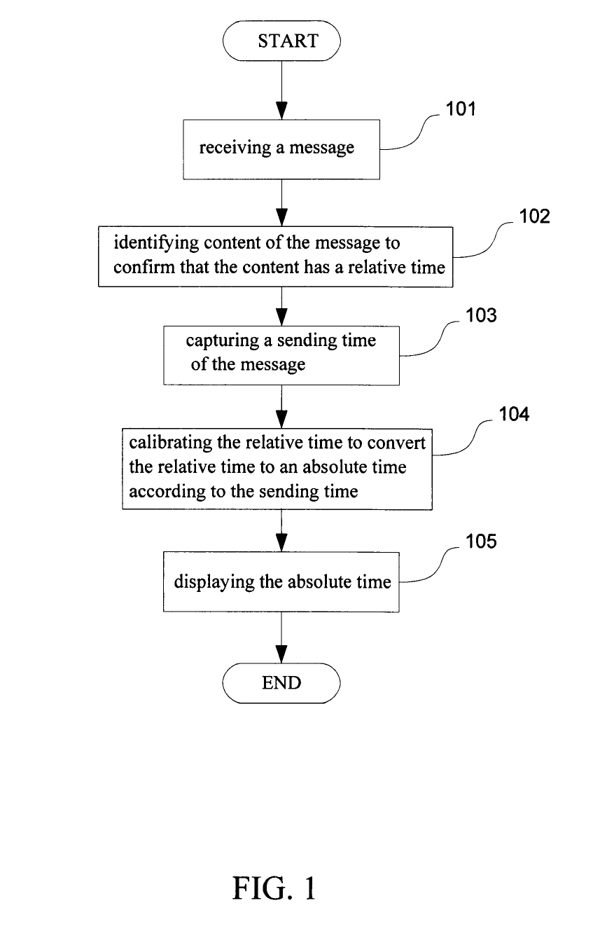

FIG. 1 is a flow chart showing a method for calibrating a relative time in the content of a message according to an embodiment of the invention.

First, a message is received (step 101). The message may be one of various kinds of messages such as a short message, an instant message, and an e-mail message transmitted via a communication network. Second, the content of the message is identified to confirm that the text description of the relative time is included in the content (step 102). The word relating to the relative time may include one or the combination of the word tomorrow, yesterday, the day after tomorrow, the day before yesterday, before, after, and time zone.

Third, a sending time of the message is captured (step 103). Fourth, the relative time is calibrated according to the sending time and converted to an absolute time (step 104). The absolute time may include one or the combination of the word year, month, date, time and time zone. Fifth, the converted absolute time is displayed (step 105), and thus a message receiver wound not be troubled or misunderstand the message.

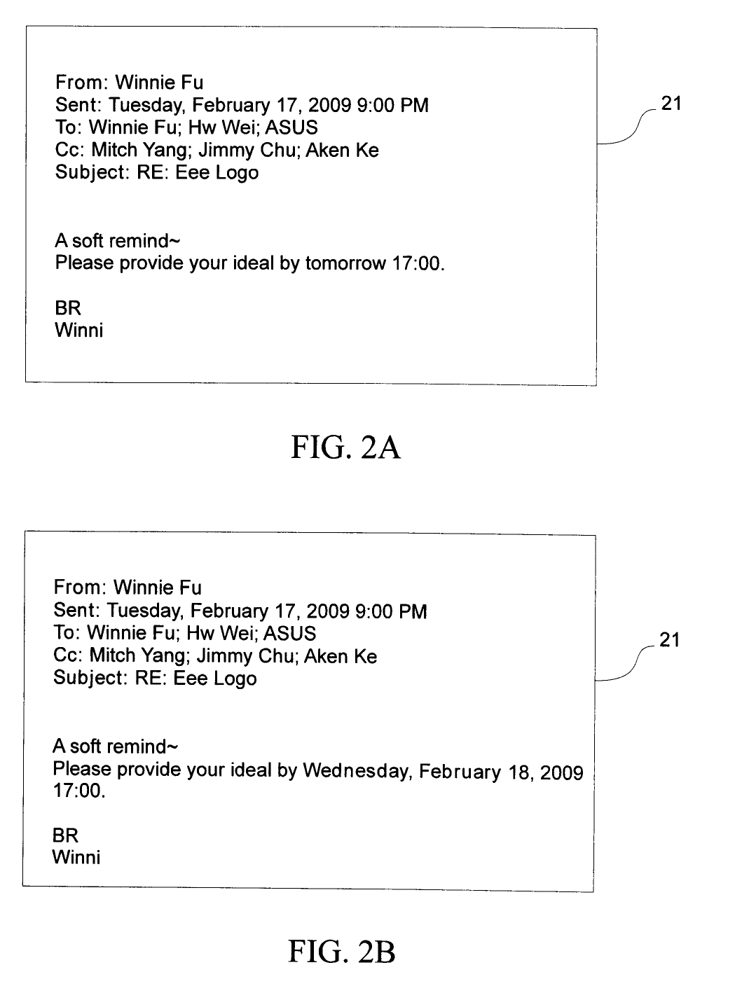

FIG. 2A is a schematic diagram showing a method for calibrating a relative time in the content of a message according to a first embodiment of the invention.

A sender transmits an e-mail message 21, and the content mentions that “tomorrow 17:00”. When the receiver receives the e-mail message 21, if a receiving date is different from the sending data of the sender, a misunderstanding may occur. Even the sending time Tuesday, Feb. 17, 2009, 9:00 PM is attached to the e-mail message 21, if the receiver receives the e-mail message 21 the next day (February 18) and neglects to note the above sending time, the time may be misinterpreted as February 19, 5:00 PM but not February 18, 5:00 PM appointed by the sender.

As shown in FIG. 2B, according to a method for calibrating a relative time in content of a message according to the invention, when the e-mail message 21 is received, the content of the e-mail message 21 is identified to include a relative time word, which is “tomorrow” mentioned in the content. Next, according to the sending time of the e-mail message 21, which is Tuesday, Feb. 17, 2009, 9:00 PM, the relative time “tomorrow” is converted and replaced by “Wednesday, Feb. 18, 2009” to be displayed in the e-mail message 21. As a result, when the receiver receives the e-mail message 21, the misunderstanding problem would not occur. At the same time, since the displayed time is the absolute time, whenever the receiver receives the e-mail message 21, the appointed time wound not be changed.

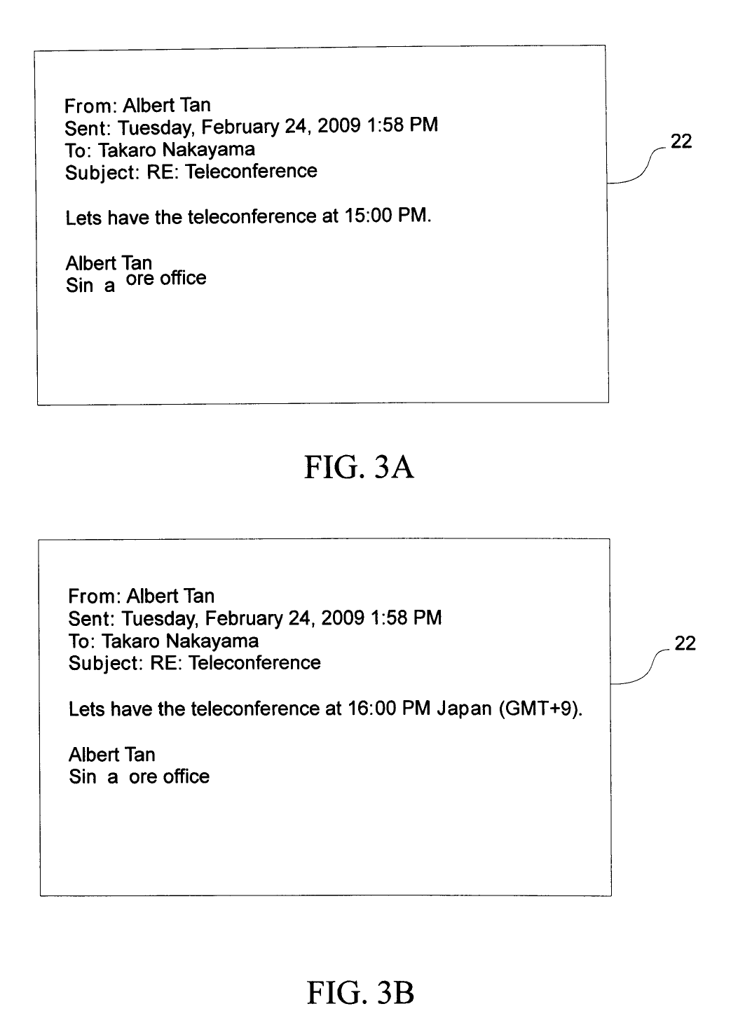

FIG. 3A is a schematic diagram showing a method for calibrating a relative time in the content of a message according to a second embodiment of the invention.

The sender sends an e-mail message 22, and the content of the e-mail message 22 mentions having a video conference at 15:00. However, the sender is at a Singapore office, and the time zone of Singapore is Greenwich Mean Time (GMT) +8; the receiver is in Japan, and the time zone of Japan is GMT+9. The time zones at two places are different, and the time difference between the two places is one hour. If the receiver in Japan does not pay attention to the time difference, he may begin to wait one hour earlier.

As shown in FIG. 3B, according to the method for calibrating the relative time in the content of the message according to the invention, when the e-mail message 22 is received, and the content of the e-mail message 22 is identified to include a relative time word, which is 15:00 in Singapore mentioned in the content. Next, according to the sending time of the e-mail message 22, that is, Tuesday, Feb. 24, 2009, 1:58 PM in Singapore, the relative time 15:00 is converted according to the sending time and replaced by 16:00 in Japan (16:00 Japan GMT+9) to be displayed in the e-mail message 22. As a result, even the receiver and the sender are in different time zones, the appointed time can be correctly determined.

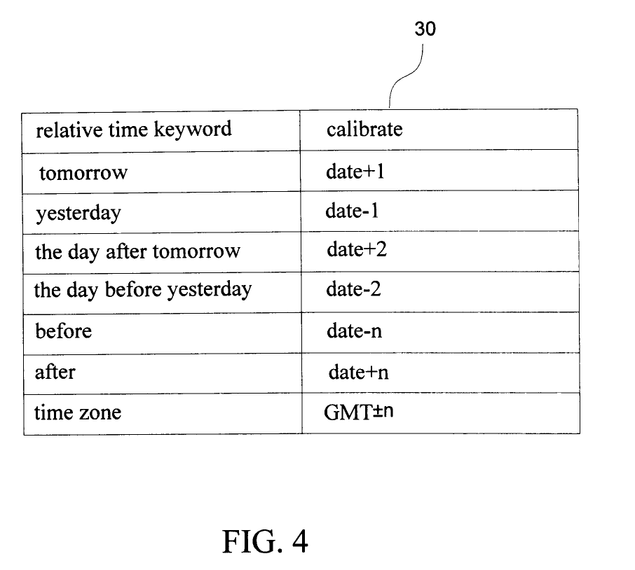

The method according to the invention may be used at one or both of the sender and the receiver, and thus the relative time is calibrated. The relative time keywords may be used to trigger identifying the relative time. The relative time keywords may be stored in a relative time keyword database 30. FIG. 4 is a schematic diagram showing a relative time keyword database of a method for calibrating a relative time in the content of a message according to an embodiment of the invention.

The relative time keywords are predefined in the relative time keyword database 30. As shown in FIG. 4, the relative time keywords include tomorrow, yesterday, the day after tomorrow, the day before yesterday, before, after, and time zone. The method for processing each keyword may be predefined. For example, tomorrow is processed by adding one to the data of the sending time (date+1), and the day after tomorrow is processed by adding two to the data of the sending time (date+2). In respect of the definition of the time zone, since a common user does not particularly note the time zone or the location in drafting the message, all time words may be set to be the keywords triggering the relative time. The time is processed and calibrated according to the method, and it is automatically calibrated to be the absolute time at the time zone of the receiver. It is adapted for being used for exchanging international messages to avoid a misunderstanding in commercial business.

Besides replacement and black display shown in FIG. 2B and FIG. 3B, the way of displaying the absolute time may be attaching before or after the relative time, highlighting, sound notification, pop-up window display, or pointer instant display. The display way may be set in the relative time keyword database 30, and it also may be set by the user (including the sender and the receiver) according to his needs.

On the other hand, besides the e-mail message, the short message, the instant message also may apply the same method to be processed. Although the sending time of the short message and the instant message may not be noted clearly, the internal code thereof includes the information of the sending time, the relative time also may be calibrated to the absolute time according to the invention.

Consequently, the method for calibrating the relative time in the content of the message according to the invention may be used in the messages such as the short message, the instant message, and the e-mail message transmitted via the communication network by identifying and calibrating the relative time in the content of the message to the absolute time. The relative time mentioned in the content of the message is converted to the absolute time to prevent the relative time mentioned in the content from being misunderstood due to the time difference, the date difference, or the time zone difference between the sending time and the receiving time of the receiver to avoid the trouble.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A method for calibrating a relative time, comprising:
receiving a message;
identifying content of the message to confirm that the content has a relative time;
capturing a sending time of the message; and
calibrating the relative time of the content to convert the relative time to an absolute time according to the sending time.

2. The method for calibrating the relative time according to claim 1, wherein the message includes a short message, an instant message and an e-mail message.

3. The method for calibrating the relative time according to claim 1, wherein the relative time is identified via a relative time keyword.

4. The method for calibrating the relative time according to claim 3, wherein the relative time keyword comprises one or the combination of the word which is tomorrow, yesterday, the day after tomorrow, the day before yesterday, before, after, and time zone.

5. The method for calibrating the relative time according to claim 4, further comprising a relative time keyword database for storing the relative time keywords.

6. The method for calibrating the relative time according to claim 1, further comprising:
displaying the absolute time.

7. The method for calibrating the relative time according to claim 5, wherein the absolute time is displayed by one or the combination of replacing the relative time, attaching to the relative time, highlighting, black display, sound notification, pop-up window display, and pointer instant display.

8. The method for calibrating the relative time according to claim 1, wherein the absolute time comprises one or the combination of the word which is year, month, date, time, and time zone.
